(19) United States
(12) Patent Application Publication
(10) Pub. No.: US 2021/0151765 A1
(43) Pub. Date: May 20, 2021

(54) METHOD OF FORMING AN ELECTRODE FOR A LITHIUM-ION ELECTROCHEMICAL CELL

(71) Applicant: GM GLOBAL TECHNOLOGY OPERATIONS LLC, Detroit, MI (US)

(72) Inventors: Nicole Ellison, Madison Heights, MI (US); Xiaosong Huang, Novi, MI (US)

(73) Assignee: GM GLOBAL TECHNOLOGY OPERATIONS LLC, Detroit, MI (US)

(21) Appl. No.: 16/686,659

(22) Filed: Nov. 18, 2019

Related U.S. Application Data
(63) Continuation of application No. 16/686,398, filed on Nov. 18, 2019.

(51) Int. Cl. H01M 4/62; H01M 4/38; H01M 10/0525; H01M 4/64

(52) U.S. Cl. CPC H01M 4/624; H01M 4/386; H01M 2004/021; H01M 4/64; H01M 4/621; H01M 10/0525

(57) ABSTRACT

A method of forming an electrode for a lithium-ion electrochemical cell includes mixing together a conductive filler component, an active material component, and a binder solution that includes a binder component and a solvent to form a slurry; casting the slurry onto a current collector to form a wet workpiece; and submersing the wet workpiece in a bath that includes a non-solvent to induce a phase inversion and form a wet electrode composition. Submersing and inducing the phase inversion includes forming a liquid-like polymer lean phase and a solid-like polymer rich phase in the wet electrode composition as the non-solvent enters the slurry. The method includes drying the wet electrode composition to form an electrode composition disposed on the current collector and thereby form the electrode.

### CROSS-REFERENCE TO RELATED APPLICATIONS

This application is a continuation of U.S. patent application Ser. No. 16/686,398, filed on Nov. 18, 2019, the disclosure of which is hereby incorporated by reference in its entirety.

### INTRODUCTION

The disclosure relates to a method of forming an electrode for a lithium-ion electrochemical cell.

Electrochemical cells or batteries are useful for converting chemical energy into electrical energy, and may be described as primary or secondary. Primary batteries are generally non-rechargeable, whereas secondary batteries are readily rechargeable and may be restored to a full charge after use. As such, secondary batteries may be useful for applications such as powering electronic devices, tools, machinery, and vehicles.

One type of secondary battery, a lithium-ion secondary battery, may include a negative electrode or anode, a positive electrode or cathode, and a separator disposed between the positive and negative electrodes. The negative electrode may be formed from a material that is capable of incorporating and releasing lithium ions during charging and discharging of the lithium-ion secondary battery. During charging of the lithium-ion secondary battery, lithium ions may move from the positive electrode to the negative electrode and embed, e.g., by intercalation, insertion, substitutional solid solution strengthening, or other means, in the material. Conversely, during battery discharge, lithium ions may be released from the material and move from the negative electrode to the positive electrode.

### SUMMARY

A method of forming an electrode for a lithium-ion electrochemical cell includes mixing together a conductive filler component, an active material component, and a binder solution that includes a binder component and a solvent to disperse the conductive filler component and the active material component within the binder solution and form a slurry. The method also includes casting the slurry onto a current collector to form a wet workpiece. In addition, the method includes submersing the wet workpiece in a bath that includes a non-solvent to thereby contact the non-solvent and the solvent, induce a phase inversion, and form a wet electrode composition. Submersing and inducing the phase inversion includes forming a liquid-like polymer lean phase and a solid-like polymer rich phase in the wet electrode composition as the non-solvent enters the slurry. The method further includes drying the wet electrode composition to form an electrode composition disposed on the current collector and thereby form the electrode.

In one aspect, drying the wet electrode may form the electrode composition having a first surface and a second surface spaced apart from and parallel to the first surface. The electrode composition may define: a plurality of channels therein each extending between the first surface and the second surface in a first direction that is generally perpendicular to the first surface and each configured for lithium ion transport between the first surface and the second surface; and a plurality of pores between the first surface and the second surface and adjacent to the plurality of channels.

In another aspect, drying may include removing the liquid-like polymer lean phase from the wet electrode composition.

In a further aspect, submersing may include soaking the slurry in the non-solvent and drying may include removing the liquid-like polymer lean phase to thereby define the plurality of channels.

In yet another aspect, submersing may form a continuous solid-like polymer rich phase in the wet electrode composition.

In an additional aspect, the method may further include, prior to drying the wet electrode composition, subjecting the wet electrode composition to a vacuum at a temperature of from 20° C. to 150° C.

In one aspect, drying the wet electrode composition may include pyrolyzing the wet electrode composition at from 350° C. to 950° C. in a nitrogen atmosphere.

In another aspect, mixing may include blending together the conductive filler component, the active material component, and the binder solution for from 3 minutes to 10 minutes.

In a further aspect, the method may further include, after mixing and prior to casting, remixing the slurry.

In yet another aspect, the method may further include, after mixing, resting the wet workpiece for from 0.1 minutes to 4 minutes in air.

In an additional aspect, the method may further include, after drying, calendaring the first surface to modify a porosity of the electrode.

A method of forming an electrode for a lithium-ion electrochemical cell includes mixing together a conductive filler component, an active material component, and a binder solution that includes a binder component and a solvent to disperse the conductive filler component and the active material component within the binder solution and form a slurry. The method also includes casting the slurry onto a current collector to form a wet workpiece. In addition, the method includes drying the wet workpiece to thereby form an electrode composition. The electrode composition has a first surface and a second surface spaced apart from and parallel to the first surface. After drying, the method includes defining: a plurality of channels within the electrode composition each extending between the first surface and the second surface in a first direction that is generally perpendicular to the first surface and each configured for lithium ion transport between the first surface and the second surface; and a plurality of pores between the first surface and the second surface and adjacent to the plurality of channels.

In one aspect, defining may include laser etching the electrode composition.

In another aspect, defining may include additively manufacturing the electrode composition.

In a further aspect, defining may include 3D printing the electrode composition.

In yet another aspect, defining may include calendaring and puncturing the electrode composition.

In an additional aspect, the method may further include, prior to drying the wet workpiece, subjecting the wet workpiece to a vacuum at a temperature of from 20° C. to 150° C.

In one aspect, drying the wet workpiece may include pyrolyzing the wet workpiece at from 350° C. to 950° C. in a nitrogen atmosphere.

In another aspect, mixing may include blending together the conductive filler component, the active material component, and the binder solution for from 3 minutes to 10 minutes.

In a further aspect, the method may include, after mixing and prior to casting, remixing the slurry.

The above features and advantages and other features and advantages of the present disclosure will be readily apparent from the following detailed description of the preferred embodiments and best modes for carrying out the present disclosure when taken in connection with the accompanying drawings and appended claims.

### BRIEF DESCRIPTION OF THE DRAWINGS

FIG. 1 is a schematic illustration of an exploded perspective view of a lithium-ion electrochemical cell including an electrode.

FIG. 2 is a schematic illustration of a cross-sectional view of a device including the lithium-ion electrochemical cell of FIG. 1.

FIG. 3 is a flowchart of a method of forming the electrode of FIG. 1.

FIG. 4 is a schematic illustration of a side view of a portion of the method of FIG. 3.

FIG. 5 is a schematic illustration of a cross-sectional view of an electrode composition during formation of the electrode of FIG. 1.

FIG. 6 is a flowchart of another embodiment of the method of FIG. 3.

### DETAILED DESCRIPTION

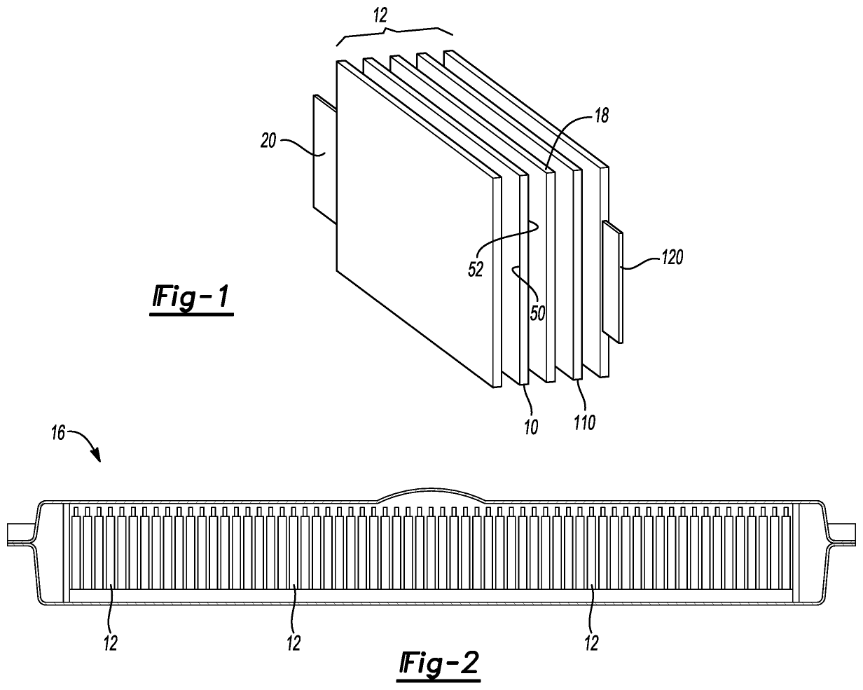

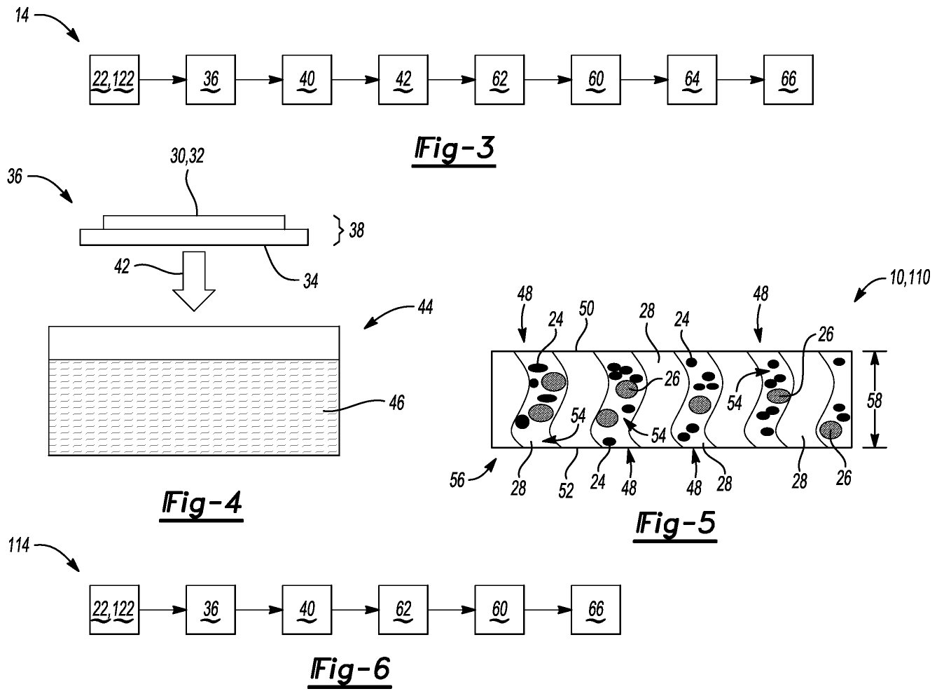

Referring to the Figures, wherein like reference numerals refer to like elements, an electrode 10 for a lithium-ion electrochemical cell 12 is shown generally in FIG. 1, and a method 14 for forming the electrode 10 is shown generally in FIG. 3. The electrode 10, lithium-ion electrochemical cell 12, and method 14 may be useful for applications requiring lithium-ion electrochemical cells 12 having excellent energy density, operating life, power performance, and charging speed. The method 14 may be simplified as compared to other manufacturing methods and scalable to mass production operations. Therefore, the electrode 10 and lithium-ion electrochemical cell 12 may be economical in terms of manufacturing time and cost.

As such, the electrode 10, lithium-ion electrochemical cell 12, and method 14 may be useful for vehicular applications such as, but not limited to, automobiles, buses, forklifts, motorcycles, bicycles, trains, trams, trolleys, spacecraft, airplanes, farming equipment, earthmoving or construction equipment, cranes, transporters, boats, and the like. Alternatively, the electrode 10, lithium-ion electrochemical cell 12, and method 14 may be useful for non-vehicular applications such as household and industrial power tools, residential appliances, electronic devices, computers, and the like. By way of a non-limiting example, the electrode 10, lithium-ion electrochemical cell 12, and method 14 may be useful for powertrain applications for non-autonomous, autonomous, or semi-autonomous vehicle applications.

Referring now to FIG. 1, the lithium-ion electrochemical cell 12 may be a secondary or rechargeable battery configured for converting energy and providing power to a device 16 (FIG. 2). That is, the device 16 may include the lithium-ion electrochemical cell 12. In one example, the device 16 may be a secondary battery module or pack configured for operation by electron transfer.

Therefore, the device 16 or secondary battery module may be useful for automotive applications, such as for a plug-in hybrid electric vehicle (PHEV). For example, the secondary battery module may be a lithium-ion secondary battery module. Further, although not shown, a plurality of secondary battery modules may be combined to form a secondary battery or pack. That is, the secondary battery module may be connected to one or more other secondary battery modules to form the secondary battery. By way of example, the secondary battery module may be sufficiently sized to provide sufficient voltage for powering a hybrid electric vehicle (HEV), an electric vehicle (EV), a plug-in hybrid electric vehicle (PHEV), and the like, e.g., approximately 300 to 400 Volts or more, depending on the required application. Alternatively, although not shown, the device 16 may be a vehicle and may include a plurality of lithium-ion electrochemical cells 12.

Further, as shown in FIG. 1, the lithium-ion electrochemical cell 12 may include a negative electrode 10 (or anode), a positive electrode 110 (or cathode) spaced apart from the negative electrode 10, and an electrolyte solution-filled separator 18 disposed between the positive electrode 110 and the negative electrode 10. That is, the electrode 10 may be the anode. Alternatively, the electrode 110 may be the cathode. In addition, the lithium-ion electrochemical cell 12 may have a positive electrode tab 120 and a negative electrode tab 20, and the lithium-ion electrochemical cell 12 may be suitable for stacking. That is, the lithium-ion electrochemical cell 12 may be packaged in a heat-sealable flexible metallized multilayer polymeric foil, or inside a metal can, that is sealed to enclose the positive electrode 110, the negative electrode 10, and the electrolyte solution-filled separator 18. Therefore, a number of lithium-ion electrochemical cells 12 may be stacked or otherwise placed adjacent to each other to form a cell stack, i.e., the secondary battery module or pack illustrated generally in FIG. 2. The actual number of lithium-ion electrochemical cells 12 may be expected to vary with the required voltage output of each secondary battery module. Likewise, the number of interconnected secondary battery modules may vary to produce the total output voltage for a specific application.

Referring again to FIG. 2, the device 16 may include the lithium-ion electrochemical cell 12. The lithium-ion electrochemical cell 12 may incorporate lithium iron phosphate, lithium vanadium pentoxide, lithium manganese dioxide, a mixed lithium-manganese-nickel oxide, a mixed lithium-nickel-cobalt oxide, a mixed lithium-manganese-nickel-cobalt oxide, and combinations thereof as a material for the positive electrode 110 (FIG. 1). The lithium-ion electrochemical cell 12 may incorporate, for example, graphite, amorphous carbon, lithium titanate, silicon, silicon oxide, tin, tin oxide, and combinations thereof as a material for the negative electrode 10 (FIG. 1).

Referring now to FIG. 3, the method 14 of forming the electrode 10, 110 includes mixing 22 together a conductive filler component 24 (FIG. 5), an active material component 26 (FIG. 5), and a binder solution that includes a binder component 28 (FIG. 5) and a solvent to disperse the conductive filler component 24 and the active material component 26 within the binder solution and form a slurry 30 (FIG. 4). For example, mixing 22 may include blending together the conductive filler component 24, the active material component 26, and the binder solution for from 3 minutes to 10 minutes, or from 4 minutes to 7 minutes, or for 5 minutes. After completion of mixing 22, the conductive filler component 24 and the active material component 26 are dispersed within the binder solution to form the slurry 30. Then, during additional processing described below, the slurry 30 is disposed on a current collector 34 (FIG. 4) to form the electrode 10, 110.

As described with reference to FIG. 5, the conductive filler component 24 may include a conductive carbon. Suitable conductive carbon may be selected for electrical conductivity and may include, but is not limited to, carbon black, carbon fibers, carbon nanofibers, carbon nanotubes, graphite, graphene, and combinations thereof. For example, the conductive filler component 24 may include vapor grown carbon fibers to provide the electrode 10, 110 with excellent stiffness and elasticity. In another example, the conductive filler component 24 may include single-wall carbon nanotubes to provide electrical contact points with the active material component 26 and an electronic conduction path to the current collector 34 (FIG. 4), even if the active material component 26 degrades during electrochemical cycling of the lithium-ion electrochemical cell 12. In another example, the conductive filler component 24 may include graphene sheets to provide the electrode 10, 110 with excellent stiffness, elasticity, and electronic conduction paths. In a further example, the conductive filler component 24 may include graphite particles to provide the electrode 10, 110 with lubrication and electronic conduction paths. The conductive filler component 24 may form an electrically-conductive network within the formed electrode 10, 110. In particular, the electrically-conductive network may be a contiguous network of carbon electrically connected to the active material component 26.

As described with continued reference to FIG. 5, the active material component 26 may be silicon, a silicon oxide, a silicon alloy, tin, or a tin alloy. In one embodiment, the active material component 26 may include silicon nanoparticles and/or silicon micron-sized particles. Further, the active material component 26 may include a plurality of active material particles coated with carbon and/or copper. That is, the copper or a mixture of copper and carbon may form a protective coating on a surface of each of the active material particles to form the active material component 26. For example, the active material component 26 may include nano- or micron-sized silicon particles or nano-porous micron-sized silicon particles coated with the protective coating of copper. In particular, the protective coating may form a film on the surface of the active material particles that may lessen parasitic reactions which may consume electrolyte during operation of the lithium-ion electrochemical cell 12.

The binder component 28 may include a polyimide. The binder component 28 may be dispersed in the solvent, such as, but not limited to, N-methyl-2-pyrrolidone to form the binder solution. Although the solvent is removed from the electrode 10, 110 during subsequent processing as set forth below, the binder component 28 may bind or glue the electrode 10, 110 together and may provide mechanical stability to electrical contact points between the conductive filler component 24, e.g., single wall carbon nanotubes, and the active material component 26. Suitable compounds, polymer binders, or polymer precursors may include, but are not limited to, nitrogen-containing compounds and polymers such as polyimides, polyamic acid, phenolic resins, epoxy resins, polyethyleneimines, polyacrylonitrile, melamine, cyanuric acid, polyamides, polyvinylidene fluoride, and combinations thereof. Suitable solvents may include, but are not limited to, N-methyl-2-pyrrolidone, dimethylformamide, dimethyl sulfoxide, methanol, ethanol, isopropanol, acetone, water, and combinations thereof.

In one specific embodiment, the binder component 28 may include a polyimide, the conductive filler component 24 may include carbon, and the active material component 26 may include silicon, e.g., silicon nanoparticles and silicon micron-sized particles.

As set forth in more detail below, the electrode 10, 110 includes a current collector 34 and an electrode composition 132 disposed on the current collector 34. For the electrode 10, 110, the binder component 28 may be present in the electrode composition 132 in a first amount; the conductive filler component 24 may be present in the electrode composition 132 in a second amount; and the active material component 26 may be present in the electrode composition 132 in a third amount that is greater than the first amount and the second amount. For example, the binder component 28 may be present in the electrode composition 132 in an amount of from 3 parts by weight to 40 parts by weight, or from 10 parts by weight to 30 parts by weight, or from 20 parts by weight to 25 parts by weight, based on 100 parts by weight of the electrode composition 132. The conductive filler component 24 may be present in the electrode composition 132 in an amount of from 2 parts by weight to 50 parts by weight, or from 10 parts by weight to 40 parts by weight, or from 30 parts by weight to 35 parts by weight, based on 100 parts by weight of the electrode composition 132. The active material component 26 may be present in the electrode composition 132 in an amount of from 30 parts by weight to 95 parts by weight, or from 40 parts by weight to 80 parts by weight, or from 50 parts by weight to 60 parts by weight, based on 100 parts by weight of the electrode composition 132. At amounts outside the aforementioned ranges, the electrode 10, 110 may not exhibit the excellent energy density, operating life, power performance, and charging speed of the claimed embodiments.

Referring again to FIG. 3, the method 14 of forming the electrode 10, 110 also includes casting 36 the slurry 30 onto the current collector 34 (FIG. 4) to form a wet workpiece 38 (FIG. 4). For example, casting 36 may include extruding or bar coating or knife coating or slot die coating the slurry 30 onto the current collector 34. In one embodiment, casting 36 may include applying the slurry 30 to the current collector 34 with a flat blade (not shown) spaced apart from the current collector 34 at a controlled distance, such that the flat blade spreads the slurry 30 over the current collector 34. Further, casting 36 the slurry 30 may be continuous or may be a batch process or a semi-batch process.

The current collector 34 may be a suitable copper matrix. For example, the current collector 34 may be a solid sheet formed from copper. Alternatively, the current collector 34 may be a foil formed from copper and may define a plurality of perforations or slits therein. Alternatively, the current collector 34 may be a woven mesh made from copper. In other embodiments, the current collector 34 may be a copper foam. In other embodiments, the current collector 34 may be a nickel or stainless steel or aluminum foil.

Alternatively, in some instances, the method 14 may include, after mixing 22 and prior to casting 36, remixing 122 (FIG. 3) the slurry 30. That is, after mixing 22 together the active material component 26, the conductive filler component 24, and the binder solution including the binder component 28 and the solvent for about 5 minutes, the method 14 may include remixing 122 the components 26, 24, 28 in the presence of the solvent for an additional time, e.g., an additional 5 minutes, to ensure adequate dispersion of the active material component 26 and the conductive filler component 24 within the binder solution.

Additionally, the method 14 may further include, after mixing 22, resting 40 the wet workpiece 38 for from 0.1 minutes to 4 minutes in air. For example, resting 40 the wet workpiece 38 in air may allow the slurry 30 to settle and spread along the current collector 34.

Referring again to FIG. 3, the method 14 also includes submersing 42 the wet workpiece 38 in a bath 44 (FIG. 4) that includes a non-solvent 46 (FIG. 4) to thereby contact the non-solvent 46 and the solvent, induce a phase inversion, and form a wet electrode composition 32 (FIG. 5). That is, after contacting the non-solvent 46 and the solvent, the wet electrode composition 32 may include the conductive filler component 24, the active material component 26, the polymer binder component 28, and a comparatively small amount of the non-solvent 46. Suitable non-solvents 46 may include, but are not limited to, water and aliphatic, semi-aromatic, or aromatic alcohols. For example, suitable examples of the non-solvent 46 may include water; alcohols such as isopropyl alcohol, glycol, and methanol; hexanes; and combinations thereof. That is, the solvent and the non-solvent 46 may be soluble in one another so that the non-solvent 46 can remove the solvent from the wet electrode composition 32, as set forth in more detail below.

In particular, submersing 42 and inducing the phase inversion includes forming a liquid-like polymer lean phase and a solid-like polymer rich phase in the wet electrode composition 32 as the non-solvent 46 enters the slurry 30. As set forth in more detail below, the phase inversion process may be specifically useful for generating a favorable arrangement of pores 48 (FIG. 5) within the wet electrode composition 32 to thereby facilitate optimal lithium ion transport during operation of the lithium-ion electrochemical cell 12. That is, the favorable arrangement of pores 48 may promote lithium ion transport during operation, which provides fast-charging capability and excellent power performance of the lithium-ion electrochemical cell 12.

Referring again to FIG. 5, the method 14 also includes drying 60 the wet electrode composition 32 to form the electrode composition 132 disposed on the current collector 34 and thereby form the electrode 10, 110. Drying 60 may include removing any residual water or non-solvent 46 after the phase inversion process. For example, drying 60 the wet electrode composition 32 may include first heat treating the wet electrode composition 32 at from room temperature, or from about 20° C. to about 25° C., to about 150° C. to remove any water or non-solvent 46 after the phase inversion process, and then pyrolyzing the wet electrode composition 32 at from 350° C. to 950° C., or from 475° C. to 925° C., or at about 800° C. in a nitrogen environment to form the dried electrode composition 132 disposed on the current collector 34 and thereby form the electrode 10, 110. In addition, as shown in FIG. 5, the method 14 may further include, prior to drying 60 the wet electrode composition 32, subjecting 62 the wet electrode composition 32 to a vacuum at a temperature of from 20° C. to 150° C., or from 75° C. to 100° C., to further prepare the wet electrode composition 32 for drying 60.

Further, drying 60 may include removing the liquid-like polymer lean phase from the wet electrode composition 32. More specifically, during drying 60, the non-solvent 46 may be removed from the wet electrode composition 32 to thereby define a plurality of channels 54 (FIG. 5) within the electrode composition 132 that are generally perpendicular to the surfaces 50, 52 of the electrode 10, 110, e.g., aligned or arranged or disposed substantially perpendicular to the surfaces 50, 52, as described in more detail below. In other words, when the surfaces 50, 52 are disposed as a top and bottom, respectively, of the electrode 10, 110, the first direction 51 may be a vertical direction such that the plurality of channels 54 extend vertically between the surfaces 50, 52. That is, submersing 42 may include inducing the phase inversion process in which the wet electrode composition 32 converts to the liquid-like polymer lean phase and the solid-like polymer rich phase, and drying 60 may include removing the liquid-like polymer lean phase to thereby define the plurality of channels 54 (FIG. 5) in the electrode composition 132.

In particular, submersing 42 may include soaking the slurry 30 in the non-solvent 46 and drying 60 may include removing the liquid-like polymer lean phase to thereby define the plurality of channels 54. That is, once the liquid-like polymer lean phase and the solid-like polymer rich phase are formed during rinsing or soaking in the bath 44 (FIG. 4), the liquid-like polymer lean phase may be removed during drying 60 to thereby define the plurality of channels 54 and the plurality of pores 48. More specifically, the solid-like polymer rich phase may be a continuous phase and the plurality of pores 48 may be defined in the electrode composition 132. However, if the solid-like polymer rich phase is discontinuous, solid particles may be present. Therefore, submersing 42 may form a continuous solid-like polymer rich phase in the wet electrode composition 32.

Referring now to FIG. 5, the electrode composition 132 formed after drying 60 includes a first surface 50 and a second surface 52 spaced apart from and parallel to the first surface 50. That is, drying 60 the wet electrode composition 32 may form the electrode composition 132 having the first surface 50 and the second surface 52 spaced apart from and parallel to the first surface 50. In addition, as best shown in FIG. 5, the electrode composition 132 defines the plurality of channels 54 therein each extending between the first surface 50 and the second surface 52 in the first direction 51 that is generally perpendicular to the first surface 50 and each configured for lithium ion transport between the first surface 50 and the second surface 52; and the plurality of pores 48 between the first surface 50 and the second surface 52 and adjacent to the plurality of channels 54.

In particular, the plurality of channels 54 may form a channel network 56 within the electrode composition 132 between the first surface 50 and the second surface 52 that is configured to minimize a travel distance 58 of lithium ions between the first surface 50 and the second surface 52. Such minimized travel distance 58 enables fast charging and excellent energy and power performance of the lithium-ion electrochemical cell 12. In one example, each of the plurality of channels 54 may extend tortuously between the first surface 50 and the second surface 52. That is, each of the plurality of channels 54 may bend or curve through the electrode composition 132 from the first surface 50 to the second surface 52. However, each of the plurality of channels 54 may also exhibit a minimized tortuosity to enable efficient lithium ion transport. Further, the plurality of channels 54 may be disposed generally parallel to one another and generally perpendicular to the first surface 50 and the second surface 52 to also enable efficient lithium ion transport.

In addition, each of the plurality of pores 48 may be arranged adjacent to a lithium transport tunnel, i.e., one of the plurality of channels 54. For example, the plurality of pores 48 may be arranged adjacent to an entirety of and/or an entrance to or exit from to one of the plurality of channels 54 defined within the electrode composition 132. As such, the plurality of pores 48 may be randomly arranged or located between the first surface 50 and the second surface 52 to promote excellent lithium ion transport.

In some instances, the method 14 may also include, after drying 60 at from room temperature to about 150° C., calendaring 64 the first surface 50 and/or the second surface 52 to modify a porosity of the electrode composition 132 and electrode 10, 110. For example, calendaring 64 may include pressing the electrode 10, 110 between two rollers (not shown) in a continuous process to smooth the first surface 50 and/or the second surface 52 and optimize the porosity of the electrode 10, 110. Similarly, the method 14 may include sanding or buffing the first surface 50 and/or the second surface 52 to remove any compacted material that may block or alter a shape of individual ones of the plurality of pores 48. The rollers may be formed from, for example, polytetrafluoroethylene-impregnated hard-anodized aluminum, polytetrafluoroethylene-coated brass, polytetrafluoroethylene-coated copper, polytetrafluoroethylene-coated stainless steel, polytetrafluoroethylene-coated nickel, polytetrafluoroethylene-coated nickel alloys, and combinations thereof. Calendaring 64 may therefore harden, flatten, and further dry the electrode composition 132.

Referring now to FIG. 6, in another embodiment, the method 114 includes, after mixing 22 together the conductive filler component 24, the active material component 26, and the binder solution including the binder component 28 and the solvent to disperse the conductive filler component 24 and the active material component 26 within the binder solution and form the slurry 30, as set forth above, and after casting 36 the slurry 30 onto the current collector 34 to form the wet workpiece 38, drying 60 the wet workpiece 38 to form the electrode composition 132. That is, in this embodiment, the wet workpiece 38 may be dried and may not be submerged into the bath 44 (FIG. 4).

For example, drying 60 the wet workpiece 38 may include first heat treating the wet workpiece 38 from at from room temperature to about 150° C., and then pyrolyzing at from 350° C. to 950° C., or from 475° C. to 925° C., or at about 800° C. in a nitrogen or inert environment to form the electrode 10, 110. In addition, as shown in FIG. 6, the method 114 may further include, prior to drying 60 the wet workpiece 38, subjecting 62 the wet workpiece 38 to a vacuum at a temperature of from 20° C. to 150° C., or from 75° C. to 100° C., to further prepare the wet workpiece 38 for drying 60. Then, after drying 60, the electrode composition 132 has the first surface 50 and the second surface 52 spaced apart from and parallel to the first surface 50.

In addition, the method 114 also includes, after drying 60, defining 66: the plurality of channels 54 within the electrode composition 132 each extending between the first surface 50 and the second surface 52 in the first direction 51 that is generally perpendicular to the first surface 50 and each configured for lithium ion transport between the first surface 50 and the second surface 52; and the plurality of pores 48 between the first surface 50 and the second surface 52 and adjacent to the plurality of channels 54 to thereby form the electrode 10, 110.

For example, the plurality of pores 48 and/or channels 54 may be defined within the electrode composition 132 by laser etching the electrode composition 132, 3D printing the electrode composition 132, puncturing the electrode composition 132, and combinations thereof. That is, in one non-limiting embodiment, defining 66 may include laser etching the electrode composition 132 to define the plurality of channels 54 and/or pores 48 therein. Stated differently, defining 66 may include performing a subtractive manufacturing process on the electrode composition 132 to remove material and thereby define the plurality of channels 54 and/or pores 48.

Alternatively or additionally, defining 66 may include additively manufacturing the electrode composition 132. That is, in one non-limiting embodiment, defining 66 may include iteratively adding material to the current collector 34 to form the electrode composition 132 and define the plurality of channels 54 and/or pores 48 therein. For example, defining 66 may include 3D printing the electrode composition 132 to thereby define the plurality of channels 54 and/or pores 48.

Further, alternatively or additionally, defining 66 may include calendaring and puncturing the electrode composition 132. That is, in one non-limiting embodiment, defining 66 may include first calendaring 64 the first surface 50 and/or the second surface 52 and then puncturing the first surface 50 and/or second surface 52 to define the plurality of pores 48 between the first and/or second surfaces 50, 52 and define the plurality of channels 54 within the electrode composition 132. For example, calendaring 64 may include pressing the electrode composition 132 between two rollers to smooth the first surface 50 and/or the second surface 52 before puncturing the surfaces 50, 52 with a needle or trocar to define the plurality of pores 48 and channels 54.

Therefore, the electrode 10, 110 and lithium-ion electrochemical cell 12 exhibit excellent energy density, operating life, performance, and charging speed. In particular, submersing 42 the wet workpiece 38 into the bath 44 and inducing the phase inversion process described above and/or defining 66 the plurality of pores 48 and channels 54 after the wet workpiece 38 is dried provides the electrode 10, 110 and lithium-ion electrochemical cell 12 with enhanced performance and fast charging capabilities by minimizing the travel distance 58 of lithium ions through the electrode composition 132 during operation of the lithium-ion electrochemical cell 12. Further, the method 14 is an economical and efficient process to form the electrode 10, 110. In particular, the method 14 may be performed continuously. Therefore, the electrode 10, 110 and lithium-ion electrochemical cell 12 may be economical in terms of manufacturing time and cost and may be scalable to mass production manufacturing operations.

While the best modes for carrying out the disclosure have been described in detail, those familiar with the art to which this disclosure relates will recognize various alternative designs and embodiments for practicing the disclosure within the scope of the appended claims.

What is claimed is:

1. A method of forming an electrode for a lithium-ion electrochemical cell, the method comprising:
mixing together a conductive filler component, an active material component, and a binder solution that includes a binder component and a solvent to disperse the conductive filler component and the active material component within the binder solution and form a slurry;
casting the slurry onto a current collector to form a wet workpiece;
submersing the wet workpiece in a bath that includes a non-solvent to thereby contact the non-solvent and the slurry, induce a phase inversion, and form a wet electrode composition;
wherein submersing and inducing the phase inversion includes forming a liquid-like polymer lean phase and a solid-like polymer rich phase in the wet electrode composition as the non-solvent enters the slurry; and
drying the wet electrode composition to form an electrode composition disposed on the current collector and thereby form the electrode.

2. The method of claim 1, wherein drying the wet electrode composition forms the electrode composition having:
a first surface; and
a second surface spaced apart from and parallel to the first surface;
wherein the electrode composition defines:
a plurality of channels therein each extending between the first surface and the second surface in a first direction that is generally perpendicular to the first surface and each configured for lithium ion transport between the first surface and the second surface; and
a plurality of pores between the first surface and the second surface and adjacent to the plurality of channels.

3. The method of claim 2, wherein drying includes removing the liquid-like polymer lean phase from the wet electrode composition.

4. The method of claim 2, wherein submersing includes soaking the slurry in the non-solvent and drying includes removing the liquid-like polymer lean phase to thereby define the plurality of channels.

5. The method of claim 2, wherein submersing forms a continuous solid-like polymer rich phase in the wet electrode composition.

6. The method of claim 1, further including, prior to drying the wet electrode composition, subjecting the wet electrode composition to a vacuum at a temperature of from 20° C. to 150° C.

7. The method of claim 1, wherein drying the wet electrode composition includes pyrolyzing the wet electrode composition at from 350° C. to 950° C. in a nitrogen atmosphere.

8. The method of claim 1, wherein mixing includes blending together the conductive filler component, the active material component, and the binder solution for from 3 minutes to 10 minutes.

9. The method of claim 1, further including, after mixing and prior to casting, remixing the slurry.

10. The method of claim 1, further including, after mixing, resting the wet workpiece for from 0.1 minutes to 4 minutes in air.

11. The method of claim 1, further including, after drying, calendaring the first surface to modify a porosity of the electrode.

12. A method of forming an electrode for a lithium-ion electrochemical cell, the method comprising:
mixing together a conductive filler component, an active material component, and a binder solution that includes a binder component and a solvent to disperse the conductive filler component and the active material component within the binder solution and form a slurry;
casting the slurry onto a current collector to form a wet workpiece;
drying the wet workpiece to thereby form an electrode composition having:
a first surface; and
a second surface spaced apart from and parallel to the first surface; and
after drying, defining:
a plurality of channels within the electrode composition each extending between the first surface and the second surface in a first direction that is generally perpendicular to the first surface and each configured for lithium ion transport between the first surface and the second surface; and
a plurality of pores between the first surface and the second surface and adjacent to the plurality of channels to thereby form the electrode.

13. The method of claim 12, wherein defining includes laser etching the electrode composition.

14. The method of claim 12, wherein defining includes additively manufacturing the electrode composition.

15. The method of claim 12, wherein defining includes 3D printing the electrode composition.

16. The method of claim 12, wherein defining includes calendaring and puncturing the electrode composition.

17. The method of claim 12, further including, prior to drying the wet workpiece, subjecting the wet workpiece to a vacuum at a temperature of from 20° C. to 150° C.

18. The method of claim 12, wherein drying the wet workpiece includes pyrolyzing the wet workpiece at from 350° C. to 950° C. in a nitrogen atmosphere.

19. The method of claim 12, wherein mixing includes blending together the conductive filler component, the active material component, and the binder solution for from 3 minutes to 10 minutes.

20. The method of claim 12, further including, after mixing and prior to casting, remixing the slurry.
